(19) United States
(12) Patent Application Publication
(10) Pub. No.: US 2021/0076677 A1
(43) Pub. Date: Mar. 18, 2021

(54) NOVEL PESTICIDAL COMBINATIONS

(71) Applicant: UPL LTD, West Bengal (IN)

(72) Inventors: Carlos Eduardo FABRI, Sao Paulo (BR); Rajju Devidas SHROFF, Mumbai, Maharashtra (IN); Jaidev Rajnikant SHROFF, Dubai (AE); Vikram Rajnikant SHROFF, Dubai (AE)

(21) Appl. No.: 16/619,964

(22) PCT Filed: May 29, 2018
(86) PCT No.: PCT/IB2018/053805

§ 371 Date: Dec. 6, 2019

(30) Foreign Application Priority Data
Jun. 9, 2017 (IN) 201731020298

(51) Int. Cl. A01N 37/22; A01N 47/14; A01N 59/02; A01N 59/20; A01N 43/38; A01N 29/04; A01N 41/06; A01N 33/04; A01N 43/66; A01N 31/00; A01N 43/56

(52) U.S. Cl. CPC A01N 37/22; A01N 47/14; A01N 59/02; A01N 59/20; A01N 43/38; A01N 43/56; A01N 41/06; A01N 33/04; A01N 43/66; A01N 31/00; A01N 29/04

(57) ABSTRACT

The present invention relates to diamide insecticides selected from broflanilide, chlorantraniliprole, cyantraniliprole, cyclaniliprole, cyhalodiamide, flubendiamide or tetraniliprole in combination with at least one multi-site fungicide and at least a second fungicidally active compound. The said combination is highly suitable for controlling unwanted animal pests, such as insects, acaricides and/or nematodes, and unwanted phytopathogenic fungi.

### TECHNICAL FIELD

The present invention relates to combinations comprising a diamide insecticide in combination with fungicidally active compounds. The said combination is highly suitable for controlling unwanted animal pests, such as insects, acaricides and/or nematodes, and unwanted phytopathogenic fungi.

### BACKGROUND OF THE INVENTION

An insecticide is a substance used to kill insects. They include ovicides and larvicides used against insect eggs and larvae, respectively.

Diamides insecticides are relatively new group of insecticides which includes flubendiamide, a highly potent lepidoptericide and chlorantraniliprole and its analogue cyantraniliprole. Evolution of diamides can be studied in article published Pest Manag Sci. 2013 January; 69(1):7-14.

Chlorantraniliprole and cyantraniliprole are anthranilic diamide insecticidal compounds which exhibit larvicidal activity as an orally ingested toxicant by targeting and disrupting the Ca²⁺ balance and ryanodine receptor. Fungicides are an integral and important tool yielded by farmers to control diseases, as well as to improve yields and quality of the crops. There are various fungicides that have been developed over the years with many desirable attributes such as specificity, systemicity, curative and eradicant action and high activity at low use rates.

Various other classes of fungicides are also known in the art, such as Quinone outside inhibitors (QoIs), ergosterol-biosynthesis inhibitors, fungicides that act on multiple sites, fungicides that affect mitosis etc.

Dithiocarbamates are known in the art as multi-site fungicides. These fungicides are used for broad-spectrum disease control in more than 70 crops. Mancozeb is especially important for controlling devastating and fast spreading diseases such as Phytophthora infestans, Venturia inaequalis etc. Dithiocarbamate fungicides, especially mancozeb, are particularly useful for disease control because of their broad spectrum of activity, high tolerance by crop plants, and general usefulness for controlling fungal plant diseases not controlled by active compounds that act on only a single target site in the fungus.

The mixing of insecticides with fungicides results in incompatibility of physical nature and also may alter efficacy of the active ingredients. Hence, an attempt has been made to know the compatibility of fungicides with insecticides and their influence of insecticides on the bioefficacy of fungicides against cabbage leaf spot when applied as mixtures under laboratory condition.

U.S. Pat. No. 7,696,232 B2 discloses composition comprising Chlorantaniliprole and other actives which includes fungicides.

There is therefore a need in the art for combinations of anthranilamide insecticidal compounds with specific fungicides that help improve spectrum. With crop tolerances decreasing, lower use rates being imposed and resistance being increasingly observed, there is a need fora combination of actives that allows for broader disease control spectrum that combines curative and preventive actives and has a lower dosage.

Therefore, embodiments of the present invention may ameliorate one or more of the above mentioned problems:

Therefore, embodiments of the present invention may provide combinations of Insecticide and fungicides that possess an enhanced efficacy over the individual active compound used in isolation.

Another object of the present invention is to provide an insecticide and fungicides combination that causes an enhanced greening of the crops to which it is administered.

Another object of the present invention is to provide a combination that causes late senescence to the crop to which it is applied thereby resulting into an increasing yield of the crop.

Yet another object of the present invention is to provide a combination that results into reduced fungal disease incidence in the crops to which it is applied.

Another object of the present invention is to provide a combination that achieves increased yield in the crops to which it is applied.

Another object of the present invention is to provide an insecticidal and fungicidal combination that causes an enhanced insecticidal activity.

Another object of the present invention is to provide a combination which enhances the protection to plants from attack or infestation by insects, acarids or nematodes.

Another object of the present invention is to provide a synergist for the anthranilamide insecticides.

Some or all these and other objects of the invention are can be achieved by way of the invention described hereinafter.

### SUMMARY OF THE INVENTION

Thus, an aspect of the present invention can provide a combination comprising:
at least one multi-site fungicide;
at least one diamide insecticide selected from broflanilide, chlorantraniliprole, cyantraniliprole, cyclaniliprole, cyhalodiamide, flubendiamide and tetraniliprole; and
at least a second fungicide.

Another aspect of the present invention can provide a combination comprising:
at least one dithiocarbamate fungicide;
at least one diamide insecticide selected from broflanilide, chlorantraniliprole, cyantraniliprole, cyclaniliprole, cyhalodiamide, flubendiamide and tetraniliprole; and
at least a second fungicide.

Yet another aspect of the present invention can provide a combination comprising:
at least one multi-site fungicide;
at least one diamide insecticide selected from broflanilide, chlorantraniliprole, cyantraniliprole, cyclaniliprole, cyhalodiamide, flubendiamide and tetraniliprole;
at least a second fungicide; and at
least a third fungicide.

### DETAILED DESCRIPTION

The term :disease control^{\check{ }} as used herein denotes control and prevention of a disease. Controlling effects include all deviation from natural development, for example: killing, retardation, decrease of the fugal disease. The term :plants^{\check{ }} refers to all physical parts of a plant, including seeds, seedlings, saplings, roots, tubers, stems, stalks, foliage and fruits. The term ‘locus_ of a plant as used herein is intended to embrace the place on which the plants are growing, where the plant propagation materials of the plants are sown or where the plant propagation materials of the plants will be placed into the soil. The term ‘plant propagation material_ is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion. The term ‘agriculturally acceptable amount of active_ refers to an amount of an active that kills or inhibits the plant disease for which control is desired, in an amount not significantly toxic to the plant being treated.

Surprisingly, the insecticidal and/or acaricidal and/or antimicrobial activity or the fungicidal activity and/or the plant-invigorating activity and/or the yield-enhancing II, activity of the active compound combinations according to the invention was found to be significantly higher than the sum of the activities of the individual active compounds.

It has surprisingly been found that the addition of a multi-site fungicide, preferably a dithiocarbamate fungicide, to the combinations of diamide insecticide compounds with at least another fungicide resulted in surprising and unexpected advantages. It was surprising that the addition of a multi-site fungicide to the combination of diamide insecticides with at least another fungicide resulted in an enhancement of the efficacy, and a surprising reduction in fungal disease incidence and enhanced pest control in comparison to the efficacy seen only with the combination of diamide insecticides with at least another fungicide. It has further been found that the addition of a multisite fungicide to these combinations and application of these combinations during the flowering stage of the crop delayed the senescence in the crop to which they were applied, which led to better greening in the crop thereby increasing the level of photosynthesis occurring within the plant, thereby leading to a greater yield from the crop to which they were applied.

These surprising advantages of the combinations of the invention were not observed when the multisite fungicide, preferably the dithiocarbamate fungicide, was not present in the combination. Therefore, these unexpected advantages of the combination of the present invention could be attributed to the inclusion of the multisite fungicide, preferably the dithiocarbamate fungicide, to the combination of a diamide insecticide with at least another fungicide.

Thus, in an aspect, the present invention provides a combination comprising:
(a) at least one diamide insecticide selected from broflanilide, chlorantraniliprole, cyantraniliprole, cyclaniliprole, cyhalodiamide, flubendiamide and tetraniliprole;
(b) at least one multisite fungicide; and
(c) at least a second fungicide.

In an embodiment, the multi-site fungicide is selected from the group consisting of dithiocarbamates, phthalimides, chloronitriles, inorganic fungicides, sulfamides, bis-guanidines, triazines, quinones, quinoxalines, dicoarboxamides and mixtures thereof.

In an embodiment, the multi-site fungicide is selected from the class of dithiocarbamate fungicides selected from asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb.

In an embodiment, the multi-site fungicide is a phthalimide fungicide selected from captan, captafol and folpet.

In an embodiment, the multi-site fungicide is a chloronitrile fungicide such as chlorothalonil.

In an embodiment, the multi-site fungicide is a sulfamide fungicide selected from dichlofluanid and tolylfluanid.

In an embodiment, the multi-site fungicide is a bis-guanidine fungicide selected from guazatine and iminoctadine.

In an embodiment, the multi-site fungicide is a triazine fungicide selected from anilazine.

In an embodiment, the multi-site fungicide is a quinone fungicide selected from dithianon.

In an embodiment, the multi-site fungicide is a quinoxaline fungicide selected from quinomethionate and chlorquinox.

In an embodiment, the multi-site fungicide is a dicarboxamide fungicide selected from fluoroimide.

In an embodiment, the multi-site fungicide is an inorganic fungicide selected from copper fungicides including copper (II) hydroxide, copper oxychloride, copper (II) sulfate, basic copper sulfate, Bordeaux mixture, copper salicylate C₇H₄O₃*Cu, cuprous oxide CU₂O; or sulphur.

In an embodiment, the combination of the present invention comprises at least one diamide insecticide selected from broflanilide, chlorantraniliprole, cyantraniliprole, cyclaniliprole, cyhalodiamide, flubendiamide and tetraniliprole.

In an embodiment, the diamide insecticide is chlorantraniliprole.

In an embodiment, the diamide insecticide is cyantraniliprole.

In an embodiment, the diamide insecticide is flubendiamide.

In an embodiment, the combination of the present invention comprises at least a second fungicide apart from the multisite fungicide.

In an embodiment, the second fungicide is a combination of at least two more fungicides. In this embodiment, these fungicides are referred to herein as the second and the third fungicide respectively. However, the second and the third fungicide are never the same fungicides, although they can be a combination of two fungicides from the same class of fungicides.

In an embodiment, the second and/or third fungicide in the combinations of the present invention may be individually selected from nucleic acids synthesis inhibitors, cytoskeleton and motor protein inhibitors, amino acids and protein synthesis inhibitors, respiration process inhibitors, signal transduction inhibitors, lipid synthesis and membrane integrity distruptors, sterol biosynthesis inhibitors, melanin synthesis inhibitors, cell wall biosynthesis inhibitors, host plant defence inductors and/or fungicides with unknown modes of action.

Thus, in an embodiment, the nucleic acid synthesis inhibitor fungicide may be selected from acylalanines such as benalaxyl, benalaxyl-M (kiralaxyl), furalaxyl, metalaxyl, metalaxyl-M (mefenoxam), oxazolidinones such as oxadixyl, butyrolactones such as ofurace, hydroxy-(2-amino-) pyrimidines such as bupirimate, dimethirimol, ethirimol, isoxazoles such as hymexazole, isothiazolones such as octhilinone, carboxylic acids such as oxolinic acid.

In an embodiment, the cytoskeleton and motor protein inhibitors may be benzimidazoles such as benomyl, carbendazim, fuberidazole, thiabendazole; thiophanates such as thiophanate, thiophanate-methyl; N-phenyl carbamates such as diethofencarb; toluamides such as zoxamide; thiazole carboxamides such as ethaboxam; phenylureas such as pencycuron, benzamides such as fluopicolide; cyanoacrylates such as phenamacril.

In an embodiment, the respiration process inhibitor fungicides may be selected from pyrimidinamines such diflumetorim; pyrazole-5-carboxamides such as tolfenpyrad, strobilurins such as azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof; oxazolidine-diones such as famoxadone; Imidazolinones such as fenamidone; benzyl-carbamates such as pyribencarb; N-methoxy-(phenyl-ethyl)-pyrazole-carboxamides such as Pyrimidinamines such as diflumetorim; cyano-imidazole such as cyazofamid; sulfamoyl-triazole such as amisulbrom; dinitrophenyl crotonates such as binapacryl, meptyldinocap, dinocap; 2,6-dinitro-anilines such as fluazinam; pyr.-hydrazones such as ferimzone; tri-phenyl tin compounds such as fentin acetate, fentin chloride, fentin hydroxide; thiophene-carboxamides such as silthiofam; triazolo-pyrimidylamine such as ametoctradin.

In an embodiment, amino acids and protein synthesis inhibitor fungicides may be selected from anilino-pyrimidines such as cyprodinil, mepanipyrim, pyrimethanil, antibiotic fungicides such as blasticidin-S, kasugamycin, streptomycin, oxytetracycline and the like.

In an embodiment, signal transduction inhibitor fungicides may be selected from aryloxyquinolines such as quinoxyfen; quinazolinones such as proquinazid; phenylpyrroles such as fenpiclonil, fludioxonil; dicarboximides such as chlozolinate, dimethachlone, iprodione, procymidone and vinclozolin.

In an embodiment, the fungicide may be selected from lipid synthesis and membrane integrity distruptors such as phosphoro-thiolates such as edifenphos Iprobenfos, pyrazophos; dithiolanes such as isoprothiolane; aromatic hydrocarbons such as biphenyl, chloroneb, dicloran, quintozene (PCNB), tecnazene (TCNB), tolclofos-methyl and the like; 1,2,4-thiadiazoles such as etridiazole; carbamates such as iodocarb, propamocarb, prothiocarb and the like.

Thus in an embodiment, the sterol biosynthesis inhibitors may be selected from triazoles such as azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, piperazines such as triforine; pyridines such as pyrifenox, pyrisoxazole; pyrimidines such as fenarimol, nuarimol imidazoles such as imazalil, oxpoconazole, pefurazoate, prochloraz, triflumizole; morpholines such as aldimorph, dodemorph, fenpropimorph, tridemorph and the like; piperidines such as fenpropidin, piperalin; spiroketal-amines such as spiroxamine; hydroxyanilides such as fenhexamid; amino-pyrazolinones such as fenpyrazamine; thiocarbamates such as pyributicarb; allylamines such as naftifine, terbinafine and mixtures thereof.

In an embodiment, cell wall biosynthesis inhibitor fungicides may be selected from peptidyl pyrimidine nucleoside fungicides such as polyoxin, cinnamic acid amides such as dimethomorph, flumorph, pyrimorph; valinamide carbamates such as benthiavalicarb, iprovalicarb, valifenalate; mandelic acid amides such as mandipropamid and mixtures thereof.

In an embodiment, melanin synthesis inhibitor fungicide may be selected from isobenzo-furanone such as fthalide; pyrrolo-quinolinones such as pyroquilon; triazolobenzo-thiazoles such as tricyclazole; cyclopropane-carboxamides such as carpropamid; carboxamides such as diclocymet; propionamides such as fenoxanil; trifluoroethyl-carbamates such as tolprocarb; and mixtures thereof.

In an embodiment, host plant defence inductors fungicides may be selected from benzo-thiadiazoles such as acibenzolar-S-methyl; benzisothiazoles such as probenazole; thiadiazole-carboxamides such as tiadinil, isotianil; polysaccharides such as laminarin; and mixtures thereof.

In an embodiment, the additional second or third fungicide is a fungicide with unknown mode of action and may be selected from cyanoacetamide-oximes such as cymoxanil; ethyl phosphonates such as foestyl ⁻Al, phophorous acid and salts; phthalamic acids such as teclofthalam; benzotriazines such as triazoxide; benzene-sulphonamides such as flusulfamide; pyridazinones such as diclomezine; thiocarbamates such as methasulfocarb; phenyl-acetamides such as cyflufenamid; aryl-phenyl-ketones such as metrafenone, pyriofenone; guanidines such as dodine; cyano-methylene-thiazolidines such as flutianil; pyrimidinone-hydrazones such as ferimzone; piperidinyl-thiazole-isoxazolines such as oxathiapiprolin; 4-quinolyl-acetates such as tebufloquin; tetrazolyloximes such as picarbutrazox; glucopyranosyl antibiotics such as validamycin; fungicides such as mineral oil, organic oils, potassium bicarbonate and mixtures thereof.

In a preferred embodiment, the second fungicide in the combinations of the present invention may be individually selected from ergosterol biosynthesis inhibitors and Quinone outside (Qo) inhibitors.

In another embodiment, the second fungicide of the present invention is a succinate dehydrogenase inhibitor fungicide (SDHI). Preferably, the succinate dehydrogenase inhibitor is selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In another preferred embodiment, the second fungicide and the third fungicide in the combinations of the present invention may be ergosterol biosynthesis inhibitors and Quinone outside (Qo) inhibitors respectively.

The ergosterol biosynthesis inhibitors may be selected from the group consisting of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, imazalil, oxpoconazole, pefurazoate, prochloraz, triflumizole, fenarimol, nuarimol, pyrifenox, pyrisoxazole, and triforine.

In another embodiment, the ergosterol biosynthesis inhibitors may be selected from prothioconazole, tebuconazole, hexaconazole, cyroconazole or epoxiconazole.

In an embodiment, the third fungicide may be a Quinone outside (Qo) inhibitor fungicide selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, and pyribencarb.

In an embodiment, the Quinone outside (Qo) inhibitor fungicide may be selected from azoxystrobin, picoxystrobin, kresoxim-methyl, pyraclostrobin and trifloxystrobin.

In an embodiment, the second and third fungicide of the present invention may be selected from a strobilurin fungicide and a conazole fungicide respectively.

In another embodiment, the second and the third fungicide may be selected from a strobilurin fungicide and a succinate dehydrogenase inhibitor fungicide respectively.

In yet another embodiment, the second the third fungicide may be selected from a conazole fungicide and a succinate dehydrogenase inhibitor fungicide respectively.

In these embodiments:
the succinate dehydrogenase inhibitor fungicide may be selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid; or
the succinate dehydrogenase inhibitor fungicide may be preferably selected from the group consisting of thifluzamide, bixafen, fluxapyroxad, isopyrazam, penthiopyrad, sedaxane and boscalid; or
the conazole fungicide may be selected from the group consisting of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, imazalil, oxpoconazole, pefurazoate, prochloraz, triflumizole, fenarimol, nuarimol, pyrifenox, pyrisoxazole, and triforine; or
the conazole fungicide may be preferably selected from the group consisting of prothioconazole, tebuconazole, hexaconazole, cyroconazole or epoxiconazole; or
the strobilurin fungicide may be selected from the group consisting of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, and pyribencarb; or
the strobilurin fungicide may be preferably selected from the group consisting of azoxystrobin, picoxystrobin, kresoxim-methyl, pyraclostrobin and trifloxystrobin.

In an embodiment, the combinations of the present invention include the following preferred combinations.

In the exemplary combinations tabulated below, the term ‘Fungicide A_ means at least one, and preferably individually each one of the fungicides selected from mancozeb (A1), folpet (A2), copper salt e.g. tribasic copper sulfate (TBCS (A3)), or chlorothalonil (A4) as being specifically combined herein with the remaining agrochemicals.

In the exemplary combinations tabulated below, the term ‘insecticide B_ means at least one, and preferably individually each one of the insecticides selected from chlorantraniliprole (B1), cyantraniliprole (B2), or flubendiamide (B3) as being specifically combined herein with the remaining fungicides.

In the exemplary combinations tabulated below, the term “Fungicide C” means at least one, and preferably individually each one of the fungicides selected from cyproconazole (C1), difenoconazole (C2), epoxiconazole (C3), hexaconazole (C4), tebuconazole (C5), tetraconazole (C6), prothioconazole (C7), metalaxyl (C8), metalaxyl-M (C9), benomyl (C10), carbendazim (C11), thiophanate-methyl (C12), zoxamide (C13), fluopicolide (C14), phenamacril (C15), cyazofamid (C16), amisulbrom (C17), tricyclazole (C18), oxathiapiprolin (C19), and picarbutrazox (C20).

In the exemplary combinations tabulated below, the term ‘Fungicide D_ means at least one, and preferably individually each one of the fungicides selected from azoxystrobin (D1), picoxystrobin (D2), pyraclostrobin (D3), kresoxim-methyl (D4), trfloxystrobin (D5), cyproconazole (D6), difenoconazole (D7), hexaconazole (D8), epoxiconazole (D9), tebuconazole (D10), tetraconazole (D11), prothioconazole (D12), benomyl (D13), carbendazim (D14), thiphanate-methyl (D15), zoxamide (D16), fluopicolide (D17), phenamacril (D18), cyazofamid (D19), amisulbrom (D20), tricyclazole (D21), oxathiapiprolin (D22), picarbutrazox (D23), metalaxyl (D24), and metalaxyl-M (D25).

| S No. | A | B | C | D |
|---|---|---|---|---|
| 1 | Fungicide A | Insecticide B | Cyproconazole | — |
| 2 | Fungicide A | Insecticide B | Difenoconazole | — |
| 3 | Fungicide A | Insecticide B | Epoxiconazole | — |
| 4 | Fungicide A | Insecticide B | Hexaconazole | — |
| 5 | Fungicide A | Insecticide B | Tebuconazole | — |
| 6 | Fungicide A | Insecticide B | Tetraconazole | — |
| 7 | Fungicide A | Insecticide B | Prothioconazole | — |
| 8 | Fungicide A | Insecticide B | — | Azoxystrobin |
| 9 | Fungicide A | Insecticide B | — | Picoxystrobin |
| 10 | Fungicide A | Insecticide B | — | Pyraclostrobin |
| 11 | Fungicide A | Insecticide B | — | Kresoxim-methyl |
| 12 | Fungicide A | Insecticide B | — | Trifloxystrobin |
| 13 | Fungicide A | Insecticide B | Cyproconazole | Azoxystrobin |
| 14 | Fungicide A | Insecticide B | Cyproconazole | Picoxystrobin |
| 15 | Fungicide A | Insecticide B | Cyproconazole | Pyraclostrobin |
| 16 | Fungicide A | Insecticide B | Cyproconazole | Kresoxim-methyl |
| 17 | Fungicide A | Insecticide B | Cyproconazole | Trifloxystrobin |
| 18 | Fungicide A | Insecticide B | Difenoconazole | Azoxystrobin |
| 19 | Fungicide A | Insecticide B | Difenoconazole | Picoxystrobin |
| 20 | Fungicide A | Insecticide B | Difenoconazole | Pyraclostrobin |
| 21 | Fungicide A | Insecticide B | Difenoconazole | Kresoxim-methyl |
| 22 | Fungicide A | Insecticide B | Difenoconazole | Trifloxystrobin |
| 23 | Fungicide A | Insecticide B | Epoxiconazole | Azoxystrobin |
| 24 | Fungicide A | Insecticide B | Epoxiconazole | Picoxystrobin |
| 25 | Fungicide A | Insecticide B | Epoxiconazole | Pyraclostrobin |
| 26 | Fungicide A | Insecticide B | Epoxiconazole | Kresoxim-methyl |
| 27 | Fungicide A | Insecticide B | Epoxiconazole | Trifloxystrobin |
| 28 | Fungicide A | Insecticide B | Hexaconazole | Azoxystrobin |
| 29 | Fungicide A | Insecticide B | Hexaconazole | Picoxystrobin |
| 30 | Fungicide A | Insecticide B | Hexaconazole | Pyraclostrobin |
| 31 | Fungicide A | Insecticide B | Hexaconazole | Kresoxim-methyl |
| 32 | Fungicide A | Insecticide B | Hexaconazole | Trifloxystrobin |
| 33 | Fungicide A | Insecticide B | Tebuconazole | Azoxystrobin |
| 34 | Fungicide A | Insecticide B | Tebuconazole | Picoxystrobin |
| 35 | Fungicide A | Insecticide B | Tebuconazole | Pyraclostrobin |
| 36 | Fungicide A | Insecticide B | Tebuconazole | Kresoxim-methyl |
| 37 | Fungicide A | Insecticide B | Tebuconazole | Trifloxystrobin |
| 38 | Fungicide A | Insecticide B | Tetraconazole | Azoxystrobin |
| 39 | Fungicide A | Insecticide B | Tetraconazole | Picoxystrobin |
| 40 | Fungicide A | Insecticide B | Tetraconazole | Pyraclostrobin |
| 41 | Fungicide A | Insecticide B | Tetraconazole | Kresoxim-methyl |
| 42 | Fungicide A | Insecticide B | Tetraconazole | Trifloxystrobin |
| 43 | Fungicide A | Insecticide B | Prothioconazole | Azoxystrobin |
| 44 | Fungicide A | Insecticide B | Prothioconazole | Picoxystrobin |
| 45 | Fungicide A | Insecticide B | Prothioconazole | Pyraclostrobin |
| 46 | Fungicide A | Insecticide B | Prothioconazole | Kresoxim-methyl |
| 47 | Fungicide A | Insecticide B | Prothioconazole | Trifloxystrobin |
| 48 | Fungicide A | Insecticide B | Metalaxyl | — |
| 49 | Fungicide A | Insecticide B | Metalaxy-m | — |
| 50 | Fungicide A | Insecticide B | Benomyl | — |
| 51 | Fungicide A | Insecticide B | Carbendazim | — |
| 52 | Fungicide A | Insecticide B | Thiophanate | — |
| | | | methyl | |
| 53 | Fungicide A | Insecticide B | Zoxamide | — |
| 54 | Fungicide A | Insecticide B | Fluopicolide | — |
| 55 | Fungicide A | Insecticide B | Phenamacril | — |
| 56 | Fungicide A | Insecticide B | Cyazofamid | — |
| 57 | Fungicide A | Insecticide B | Amisulbrom | — |
| 58 | Fungicide A | Insecticide B | Tricyclazole | — |
| 59 | Fungicide A | Insecticide B | Oxathiapiprolin | — |
| 60 | Fungicide A | Insecticide B | Picarbutrazox | — |
| 61 | Fungicide A | Insecticide B | Metalaxyl/ | Cyproconazole |
| | | | Metalaxyl-M | |
| 62 | Fungicide A | Insecticide B | Metalaxyl/ | Difenoconazole |
| | | | Metalaxyl-M | |
| 63 | Fungicide A | Insecticide B | Metalaxyl/ | Epoxiconazole |
| | | | Metalaxyl-M | |
| 64 | Fungicide A | Insecticide B | Metalaxyl/ | Hexaconazole |
| | | | Metalaxyl-M | |
| 65 | Fungicide A | Insecticide B | Metalaxyl/ | Tebuconazole |
| | | | Metalaxyl-M | |
| 66 | Fungicide A | Insecticide B | Metalaxyl/ | Tetraconazole |
| | | | Metalaxyl-M | |
| 67 | Fungicide A | Insecticide B | Metalaxyl/ | Prothioconazole |
| | | | Metalaxyl-M | |
| 68 | Fungicide A | Insecticide B | Metalaxyl/ | Azoxystrobin |
| | | | Metalaxyl-M | |
| 69 | Fungicide A | Insecticide B | Metalaxyl/ | Picoxystrobin |
| | | | Metalaxyl-M | |
| 70 | Fungicide A | Insecticide B | Metalaxyl/ | Pyraclostrobin |
| | | | Metalaxyl-M | |
| 71 | Fungicide A | Insecticide B | Metalaxyl/ | Kresoxim-methyl |
| | | | Metalaxyl-M | |
| 72 | Fungicide A | Insecticide B | Metalaxyl/ | Benomyl |
| | | | Metalaxyl-M | |
| 73 | Fungicide A | Insecticide B | Metalaxyl/ | Carbendazim |
| | | | Metalaxyl-M | |
| 74 | Fungicide A | Insecticide B | Metalaxyl/ | Thiophanate |
| | | | Metalaxyl-M | methyl |
| 75 | Fungicide A | Insecticide B | Metalaxyl/ | Z oxamide |
| | | | Metalaxyl-M | |
| 76 | Fungicide A | Insecticide B | Metalaxyl/ | Fluopicolide |
| | | | Metalaxyl-M | |
| 77 | Fungicide A | Insecticide B | Metalaxyl/ | Phenamacril |
| | | | Metalaxyl-M | |
| 78 | Fungicide A | Insecticide B | Metalaxyl/ | Cyazofamid |
| | | | Metalaxyl-M | |
| 79 | Fungicide A | Insecticide B | Metalaxyl/ | Amisulbrom |
| | | | Metalaxyl-M | |
| 80 | Fungicide A | Insecticide B | Metalaxyl/ | Tricyclazole |
| | | | Metalaxyl-M | |
| 81 | Fungicide A | Insecticide B | Metalaxyl/ | Oxathiapiprolin |
| | | | Metalaxyl-M | |
| 82 | Fungicide A | Insecticide B | Metalaxyl/ | Picarbutrazox |
| | | | Metalaxyl-M | |
| 83 | Fungicide A | Insecticide B | Benomyl | Cyproconazole |
| 84 | Fungicide A | Insecticide B | Benomyl | Difenoconazole |
| 85 | Fungicide A | Insecticide B | Benomyl | Epoxiconazole |
| 86 | Fungicide A | Insecticide B | Benomyl | Hexaconazole |
| 87 | Fungicide A | Insecticide B | Benomyl | Tebuconazole |
| 88 | Fungicide A | Insecticide B | Benomyl | Tetraconazole |
| 89 | Fungicide A | Insecticide B | Benomyl | Prothioconazole |
| 90 | Fungicide A | Insecticide B | Benomyl | Azoxystrobin |
| 91 | Fungicide A | Insecticide B | Benomyl | Picoxystrobin |
| 92 | Fungicide A | Insecticide B | Benomyl | Pyraclostrobin |
| 93 | Fungicide A | Insecticide B | Benomyl | Kresoxim-methyl |
| 94 | Fungicide A | Insecticide B | Benomyl | Metalaxyl/ |
| | | | | Metalaxyl-M |
| 95 | Fungicide A | Insecticide B | Benomyl | Carbendazim |
| 96 | Fungicide A | Insecticide B | Benomyl | Thiophanate |
| | | | | methyl |
| 97 | Fungicide A | Insecticide B | Benomyl | Zoxamide |
| 98 | Fungicide A | Insecticide B | Benomyl | Fluopicolide |
| 99 | Fungicide A | Insecticide B | Benomyl | Phenamacril |
| 100 | Fungicide A | Insecticide B | Benomyl | Cyazofamid |
| 101 | Fungicide A | Insecticide B | Benomyl | amisulbrom |
| 102 | Fungicide A | Insecticide B | Benomyl | Tricyclazole |
| 103 | Fungicide A | Insecticide B | Benomyl | Oxathiapiprolin |
| 104 | Fungicide A | Insecticide B | Benomyl | Picarbutrazox |
| 105 | Fungicide A | Insecticide B | Carbendazim | Cyproconazole |
| 106 | Fungicide A | Insecticide B | Carbendazim | Difenoconazole |
| 107 | Fungicide A | Insecticide B | Carbendazim | Epoxiconazole |
| 108 | Fungicide A | Insecticide B | Carbendazim | Hexaconazole |
| 109 | Fungicide A | Insecticide B | Carbendazim | Tebuconazole |
| 110 | Fungicide A | Insecticide B | Carbendazim | Tetraconazole |
| 111 | Fungicide A | Insecticide B | Carbendazim | Prothioconazole |
| 112 | Fungicide A | Insecticide B | Carbendazim | Azoxystrobin |
| 113 | Fungicide A | Insecticide B | Carbendazim | Picoxystrobin |
| 114 | Fungicide A | Insecticide B | Carbendazim | Pyraclostrobin |
| 115 | Fungicide A | Insecticide B | Carbendazim | Kresoxim-methyl |
| 116 | Fungicide A | Insecticide B | Carbendazim | Benomyl |
| 117 | Fungicide A | Insecticide B | Carbendazim | Metalaxyl/ |
| | | | | Metalaxyl-M |
| 118 | Fungicide A | Insecticide B | Carbendazim | Thiophanate |
| | | | | methyl |
| 119 | Fungicide A | Insecticide B | Carbendazim | Zoxamide |
| 120 | Fungicide A | Insecticide B | Carbendazim | Fluopicolide |
| 121 | Fungicide A | Insecticide B | Carbendazim | Phenamacril |
| 122 | Fungicide A | Insecticide B | Carbendazim | Cyazofamid |
| 123 | Fungicide A | Insecticide B | Carbendazim | Amisulbrom |
| 124 | Fungicide A | Insecticide B | Carbendazim | Tricyclazole |
| 125 | Fungicide A | Insecticide B | Carbendazim | Oxathiapiprolin |
| 126 | Fungicide A | Insecticide B | Carbendazim | Picarbutrazox |
| 127 | Fungicide A | Insecticide B | Thiophanate | Cyproconazole |
| | | | methyl | |
| 128 | Fungicide A | Insecticide B | Thiophanate | Difenoconazole |
| | | | methyl | |
| 129 | Fungicide A | Insecticide B | Thiophanate | Epoxiconazole |
| | | | methyl | |
| 130 | Fungicide A | Insecticide B | Thiophanate | Hexaconazole |
| | | | methyl | |
| 131 | Fungicide A | Insecticide B | Thiophanate | Tebuconazole |
| | | | methyl | |
| 132 | Fungicide A | Insecticide B | Thiophanate | Tetraconazole |
| | | | methyl | |
| 133 | Fungicide A | Insecticide B | Thiophanate | Prothioconazole |
| | | | methyl | |
| 134 | Fungicide A | Insecticide B | Thiophanate | Azoxystrobin |
| | | | methyl | |
| 135 | Fungicide A | Insecticide B | Thiophanate | Picoxystrobin |
| | | | methyl | |
| 136 | Fungicide A | Insecticide B | Thiophanate | Pyraclostrobin |
| | | | methyl | |
| 137 | Fungicide A | Insecticide B | Thiophanate | Kresoxim-methyl |
| | | | methyl | |
| 138 | Fungicide A | Insecticide B | Thiophanate | Benomyl |
| | | | methyl | |
| 139 | Fungicide A | Insecticide B | Thiophanate | Carbendazim |
| | | | methyl | |
| 140 | Fungicide A | Insecticide B | Thiophanate | Metalaxyl/ |
| | | | methyl | Metalaxyl-M |
| 141 | Fungicide A | Insecticide B | Thiophanate | Zoxamide |
| | | | methyl | |
| 142 | Fungicide A | Insecticide B | Thiophanate | Fluopicolide |
| | | | methyl | |
| 143 | Fungicide A | Insecticide B | Thiophanate | Phenamacril |
| | | | methyl | |
| 144 | Fungicide A | Insecticide B | Thiophanate | Cyazofamid |
| | | | methyl | |
| 145 | Fungicide A | Insecticide B | Thiophanate | Amisulbrom |
| | | | methyl | |
| 146 | Fungicide A | Insecticide B | Thiophanate | Tricyclazole |
| | | | methyl | |
| 147 | Fungicide A | Insecticide B | Thiophanate | Oxathiapiprolin |
| | | | methyl | |
| 148 | Fungicide A | Insecticide B | Thiophanate | Picarbutrazox |
| | | | methyl | |
| 149 | Fungicide A | Insecticide B | Zoxamide | Cyproconazole |
| 150 | Fungicide A | Insecticide B | Zoxamide | Difenoconazole |
| 151 | Fungicide A | Insecticide B | Zoxamide | Epoxiconazole |
| 152 | Fungicide A | Insecticide B | Zoxamide | Hexaconazole |
| 153 | Fungicide A | Insecticide B | Zoxamide | Tebuconazole |
| 154 | Fungicide A | Insecticide B | Zoxamide | Tetraconazole |
| 155 | Fungicide A | Insecticide B | Zoxamide | Prothioconazole |
| 156 | Fungicide A | Insecticide B | Zoxamide | Azoxystrobin |
| 157 | Fungicide A | Insecticide B | Zoxamide | Picoxystrobin |
| 158 | Fungicide A | Insecticide B | Zoxamide | Pyraclostrobin |
| 159 | Fungicide A | Insecticide B | Zoxamide | Kresoxim-methyl |
| 160 | Fungicide A | Insecticide B | Zoxamide | Benomyl |
| 161 | Fungicide A | Insecticide B | Zoxamide | Carbendazim |
| 162 | Fungicide A | Insecticide B | Zoxamide | Metalaxyl/ |
| | | | | Metalaxyl-M |
| 163 | Fungicide A | Insecticide B | Zoxamide | Thiophanate |
| | | | | methyl |
| 164 | Fungicide A | Insecticide B | Zoxamide | Fluopicolide |
| 165 | Fungicide A | Insecticide B | Zoxamide | Phenamacril |
| 166 | Fungicide A | Insecticide B | Zoxamide | Cyazofamid |
| 167 | Fungicide A | Insecticide B | Zoxamide | Amisulbrom |
| 168 | Fungicide A | Insecticide B | Zoxamide | Tricyclazole |
| 169 | Fungicide A | Insecticide B | Zoxamide | Oxathiapiprolin |
| 170 | Fungicide A | Insecticide B | Zoxamide | Picarbutrazox |
| 171 | Fungicide A | Insecticide B | Fluopicolide | Cyproconazole |
| 172 | Fungicide A | Insecticide B | Fluopicolide | Difenoconazole |
| 173 | Fungicide A | Insecticide B | Fluopicolide | Epoxiconazole |
| 174 | Fungicide A | Insecticide B | Fluopicolide | Hexaconazole |
| 175 | Fungicide A | Insecticide B | Fluopicolide | Tebuconazole |
| 176 | Fungicide A | Insecticide B | Fluopicolide | Tetraconazole |
| 177 | Fungicide A | Insecticide B | Fluopicolide | Prothioconazole |
| 178 | Fungicide A | Insecticide B | Fluopicolide | Azoxystrobin |
| 179 | Fungicide A | Insecticide B | Fluopicolide | Picoxystrobin |
| 180 | Fungicide A | Insecticide B | Fluopicolide | Pyraclostrobin |
| 181 | Fungicide A | Insecticide B | Fluopicolide | Kresoxim-methyl |
| 182 | Fungicide A | Insecticide B | Fluopicolide | Benomyl |
| 183 | Fungicide A | Insecticide B | Fluopicolide | Carbendazim |
| 184 | Fungicide A | Insecticide B | Fluopicolide | Metalaxyl/ |
| | | | | Metalaxyl-M |
| 185 | Fungicide A | Insecticide B | Fluopicolide | Thiophanate |
| | | | | methyl |
| 186 | Fungicide A | Insecticide B | Fluopicolide | Zoxamide |
| 187 | Fungicide A | Insecticide B | Fluopicolide | Phenamacril |
| 188 | Fungicide A | Insecticide B | Fluopicolide | Cyazofamid |
| 189 | Fungicide A | Insecticide B | Fluopicolide | Amisulbrom |
| 190 | Fungicide A | Insecticide B | Fluopicolide | Tricyclazole |
| 191 | Fungicide A | Insecticide B | Fluopicolide | Oxathiapiprolin |
| 192 | Fungicide A | Insecticide B | Fluopicolide | Picarbutrazox |
| 193 | Fungicide A | Insecticide B | Phenamacril | Cyproconazole |
| 194 | Fungicide A | Insecticide B | Phenamacril | Difenoconazole |
| 195 | Fungicide A | Insecticide B | Phenamacril | Epoxiconazole |
| 196 | Fungicide A | Insecticide B | Phenamacril | Hexaconazole |
| 197 | Fungicide A | Insecticide B | Phenamacril | Tebuconazole |
| 198 | Fungicide A | Insecticide B | Phenamacril | Tetraconazole |
| 199 | Fungicide A | Insecticide B | Phenamacril | Prothioconazole |
| 200 | Fungicide A | Insecticide B | Phenamacril | Azoxystrobin |
| 201 | Fungicide A | Insecticide B | Phenamacril | Picoxystrobin |
| 202 | Fungicide A | Insecticide B | Phenamacril | Pyraclostrobin |
| 203 | Fungicide A | Insecticide B | Phenamacril | Kresoxim-methyl |
| 204 | Fungicide A | Insecticide B | Phenamacril | Benomyl |
| 205 | Fungicide A | Insecticide B | Phenamacril | Carbendazim |
| 206 | Fungicide A | Insecticide B | Phenamacril | Metalaxyl/ |
| | | | | Metalaxyl-M |
| 207 | Fungicide A | Insecticide B | Phenamacril | Thiophanate |
| | | | | methyl |
| 208 | Fungicide A | Insecticide B | Phenamacril | Zoxamide |
| 209 | Fungicide A | Insecticide B | Phenamacril | Fluopicolide |
| 210 | Fungicide A | Insecticide B | Phenamacril | Cyazofamid |
| 211 | Fungicide A | Insecticide B | Phenamacril | Amisulbrom |
| 212 | Fungicide A | Insecticide B | Phenamacril | Tricyclazole |
| 213 | Fungicide A | Insecticide B | Phenamacril | Oxathiapiprolin |
| 214 | Fungicide A | Insecticide B | Phenamacril | Picarbutrazox |
| 215 | Fungicide A | Insecticide B | Cyazofamid | Cyproconazole |
| 216 | Fungicide A | Insecticide B | Cyazofamid | Difenoconazole |
| 217 | Fungicide A | Insecticide B | Cyazofamid | Epoxiconazole |
| 218 | Fungicide A | Insecticide B | Cyazofamid | Hexaconazole |
| 219 | Fungicide A | Insecticide B | Cyazofamid | Tebuconazole |
| 220 | Fungicide A | Insecticide B | Cyazofamid | Tetraconazole |
| 221 | Fungicide A | Insecticide B | Cyazofamid | Prothioconazole |
| 222 | Fungicide A | Insecticide B | Cyazofamid | Azoxystrobin |
| 223 | Fungicide A | Insecticide B | Cyazofamid | Picoxystrobin |
| 224 | Fungicide A | Insecticide B | cyazofamid | Pyraclostrobin |
| 225 | Fungicide A | Insecticide B | Cyazofamid | Kresoxim-methyl |
| 226 | Fungicide A | Insecticide B | Cyazofamid | Benomyl |
| 227 | Fungicide A | Insecticide B | Cyazofamid | Carbendazim |
| 228 | Fungicide A | Insecticide B | Cyazofamid | Metalaxyl/ |
| | | | | Metalaxyl-M |
| 229 | Fungicide A | Insecticide B | Cyazofamid | Thiophanate |
| | | | | methyl |
| 230 | Fungicide A | Insecticide B | Cyazofamid | Zoxamide |
| 231 | Fungicide A | Insecticide B | Cyazofamid | Fluopicolide |
| 232 | Fungicide A | Insecticide B | Cyazofamid | Phenamacril |
| 233 | Fungicide A | Insecticide B | Cyazofamid | Amisulbrom |
| 234 | Fungicide A | Insecticide B | Cyazofamid | Tricyclazole |
| 235 | Fungicide A | Insecticide B | Cyazofamid | Oxathiapiprolin |
| 236 | Fungicide A | Insecticide B | Cyazofamid | Picarbutrazox |
| 237 | Fungicide A | Insecticide B | Amisulbrom | Cyproconazole |
| 238 | Fungicide A | Insecticide B | Amisulbrom | Difenoconazole |
| 239 | Fungicide A | Insecticide B | Amisulbrom | Epoxiconazole |
| 240 | Fungicide A | Insecticide B | Amisulbrom | Hexaconazole |
| 241 | Fungicide A | Insecticide B | Amisulbrom | Tebuconazole |
| 242 | Fungicide A | Insecticide B | Amisulbrom | Tetraconazole |
| 243 | Fungicide A | Insecticide B | Amisulbrom | Prothioconazole |
| 244 | Fungicide A | Insecticide B | Amisulbrom | Azoxystrobin |
| 245 | Fungicide A | Insecticide B | Amisulbrom | Picoxystrobin |
| 246 | Fungicide A | Insecticide B | Amisulbrom | Pyraclostrobin |
| 247 | Fungicide A | Insecticide B | Amisulbrom | Kresoxim-methyl |
| 248 | Fungicide A | Insecticide B | Amisulbrom | Benomyl |
| 249 | Fungicide A | Insecticide B | Amisulbrom | Metalaxyl/ |
| | | | | Metalaxyl-M |
| 250 | Fungicide A | Insecticide B | Amisulbrom | Carbendazim |
| 251 | Fungicide A | Insecticide B | Amisulbrom | Thiophanate |
| | | | | methyl |
| 252 | Fungicide A | Insecticide B | Amisulbrom | Zoxamide |
| 253 | Fungicide A | Insecticide B | Amisulbrom | Fluopicolide |
| 254 | Fungicide A | Insecticide B | Amisulbrom | Cyazofamid |
| 255 | Fungicide A | Insecticide B | Amisulbrom | Tricyclazole |
| 256 | Fungicide A | Insecticide B | Amisulbrom | Oxathiapiprolin |
| 257 | Fungicide A | Insecticide B | Amisulbrom | Picarbutrazox |
| 258 | Fungicide A | Insecticide B | Tricyclazole | Cyproconazole |
| 259 | Fungicide A | Insecticide B | Tricyclazole | Difenoconazole |
| 260 | Fungicide A | Insecticide B | Tricyclazole | Epoxiconazole |
| 261 | Fungicide A | Insecticide B | Tricyclazole | Hexaconazole |
| 262 | Fungicide A | Insecticide B | Tricyclazole | Tebuconazole |
| 263 | Fungicide A | Insecticide B | Tricyclazole | Tetraconazole |
| 264 | Fungicide A | Insecticide B | Tricyclazole | Prothioconazole |
| 265 | Fungicide A | Insecticide B | Tricyclazole | Azoxystrobin |
| 266 | Fungicide A | Insecticide B | Tricyclazole | Picoxystrobin |
| 267 | Fungicide A | Insecticide B | Tricyclazole | Pyraclostrobin |
| 268 | Fungicide A | Insecticide B | Tricyclazole | Kresoxim-methyl |
| 269 | Fungicide A | Insecticide B | Tricyclazole | Benomyl |
| 270 | Fungicide A | Insecticide B | Tricyclazole | Carbendazim |
| 271 | Fungicide A | Insecticide B | Tricyclazole | Metalaxyl/ |
| | | | | Metalaxyl-M |
| 272 | Fungicide A | Insecticide B | Tricyclazole | Thiophanate |
| | | | | methyl |
| 273 | Fungicide A | Insecticide B | Tricyclazole | Zoxamide |
| 274 | Fungicide A | Insecticide B | Tricyclazole | Fluopicolide |
| 275 | Fungicide A | Insecticide B | Tricyclazole | Cyazofamid |
| 276 | Fungicide A | Insecticide B | Tricyclazole | Amisulbrom |
| 277 | Fungicide A | Insecticide B | Tricyclazole | Oxathiapiprolin |
| 278 | Fungicide A | Insecticide B | Tricyclazole | Picarbutrazox |
| 279 | Fungicide A | Insecticide B | Picarbutrazox | Cyproconazole |
| 280 | Fungicide A | Insecticide B | Picarbutrazox | Difenoconazole |
| 281 | Fungicide A | Insecticide B | Picarbutrazox | Epoxiconazole |
| 282 | Fungicide A | Insecticide B | Picarbutrazox | Hexaconazole |
| 283 | Fungicide A | Insecticide B | Picarbutrazox | Tebuconazole |
| 284 | Fungicide A | Insecticide B | Picarbutrazox | Tetraconazole |
| 285 | Fungicide A | Insecticide B | Picarbutrazox | Prothioconazole |
| 286 | Fungicide A | Insecticide B | Picarbutrazox | Azoxystrobin |
| 287 | Fungicide A | Insecticide B | Picarbutrazox | Picoxystrobin |
| 288 | Fungicide A | Insecticide B | Picarbutrazox | Pyraclostrobin |
| 289 | Fungicide A | Insecticide B | Picarbutrazox | Kresoxim-methyl |
| 290 | Fungicide A | Insecticide B | Picarbutrazox | Benomyl |
| 291 | Fungicide A | Insecticide B | Picarbutrazox | Carbendazim |
| 292 | Fungicide A | Insecticide B | Picarbutrazox | Metalaxyl/ |
| | | | | Metalaxyl-M |
| 293 | Fungicide A | Insecticide B | Picarbutrazox | Thiophanate |
| | | | | methyl |
| 294 | Fungicide A | Insecticide B | Picarbutrazox | Zoxamide |
| 295 | Fungicide A | Insecticide B | Picarbutrazox | Fluopicolide |
| 296 | Fungicide A | Insecticide B | Picarbutrazox | Cyazofamid |
| 297 | Fungicide A | Insecticide B | Picarbutrazox | Amisulbrom |
| 298 | Fungicide A | Insecticide B | Picarbutrazox | Oxathiapiprolin |
| 299 | Fungicide A | Insecticide B | Oxathiapiprolin | Cyproconazole |
| 300 | Fungicide A | Insecticide B | Oxathiapiprolin | Difenoconazole |
| 301 | Fungicide A | Insecticide B | Oxathiapiprolin | Epoxiconazole |
| 302 | Fungicide A | Insecticide B | Oxathiapiprolin | Hexaconazole |
| 303 | Fungicide A | Insecticide B | Oxathiapiprolin | Tebuconazole |
| 304 | Fungicide A | Insecticide B | Oxathiapiprolin | Tetraconazole |
| 305 | Fungicide A | Insecticide B | Oxathiapiprolin | Prothioconazole |
| 306 | Fungicide A | Insecticide B | Oxathiapiprolin | Azoxystrobin |
| 307 | Fungicide A | Insecticide B | Oxathiapiprolin | Picoxystrobin |
| 308 | Fungicide A | Insecticide B | Oxathiapiprolin | Pyraclostrobin |
| 309 | Fungicide A | Insecticide B | Oxathiapiprolin | Kresoxim-methyl |
| 310 | Fungicide A | Insecticide B | Oxathiapiprolin | Benomyl |
| 311 | Fungicide A | Insecticide B | Oxathiapiprolin | Carbendazim |
| 312 | Fungicide A | Insecticide B | Oxathiapiprolin | Metalaxyl/ |
| | | | | Metalaxyl-M |
| 313 | Fungicide A | Insecticide B | Oxathiapiprolin | Thiophanate |
| | | | | methyl |
| 314 | Fungicide A | Insecticide B | Oxathiapiprolin | Zoxamide |
| 315 | Fungicide A | Insecticide B | Oxathiapiprolin | Fluopicolide |
| 316 | Fungicide A | Insecticide B | Oxathiapiprolin | Cyazofamid |
| 317 | Fungicide A | Insecticide B | Oxathiapiprolin | Amisulbrom |
| 318 | Fungicide A | Insecticide B | Oxathiapiprolin | Picarbutrazox |

In an embodiment of the combinations of the present invention, the preferred multisite fungicide is mancozeb and the preferred diamide insecticidal compound is chlorantraniliprole.

In an embodiment, the combinations of the present invention include the following preferred combinations:

| S No. | I | II | III | IV |
|---|---|---|---|---|
| 319 | Mancozeb | Chlorantraniliprole | Cyproconazole | — |
| 320 | Mancozeb | Chlorantraniliprole | Difenoconazole | — |
| 321 | Mancozeb | Chlorantraniliprole | Epoxiconazole | — |
| 322 | Mancozeb | Chlorantraniliprole | Hexaconazole | — |
| 323 | Mancozeb | Chlorantraniliprole | Tebuconazole | — |
| 324 | Mancozeb | Chlorantraniliprole | Tetraconazole | — |
| 325 | Mancozeb | Chlorantraniliprole | Prothioconazole | — |
| 326 | Mancozeb | Chlorantraniliprole | — | Azoxystrobin |
| 327 | Mancozeb | Chlorantraniliprole | — | Picoxystrobin |
| 328 | Mancozeb | Chlorantraniliprole | — | Pyraclostrobin |
| 329 | Mancozeb | Chlorantraniliprole | — | Kresoxim-methyl |
| 330 | Mancozeb | Chlorantraniliprole | — | Trifloxystrobin |
| 331 | Mancozeb | Chlorantraniliprole | Cyproconazole | Azoxystrobin |
| 332 | Mancozeb | Chlorantraniliprole | Cyproconazole | Picoxystrobin |
| 333 | Mancozeb | Chlorantraniliprole | Cyproconazole | Pyraclostrobin |
| 334 | Mancozeb | Chlorantraniliprole | Cyproconazole | Kresoxim-methyl |
| 335 | Mancozeb | Chlorantraniliprole | Cyproconazole | Trifloxystrobin |
| 336 | Mancozeb | Chlorantraniliprole | Difenoconazole | Azoxystrobin |
| 337 | Mancozeb | Chlorantraniliprole | Difenoconazole | Picoxystrobin |
| 338 | Mancozeb | Chlorantraniliprole | Difenoconazole | Pyraclostrobin |
| 339 | Mancozeb | Chlorantraniliprole | Difenoconazole | Kresoxim-methyl |
| 340 | Mancozeb | Chlorantraniliprole | Difenoconazole | Trifloxystrobin |
| 341 | Mancozeb | Chlorantraniliprole | Epoxiconazole | Azoxystrobin |
| 342 | Mancozeb | Chlorantraniliprole | Epoxiconazole | Picoxystrobin |
| 343 | Mancozeb | Chlorantraniliprole | Epoxiconazole | Pyraclostrobin |
| 344 | Mancozeb | Chlorantraniliprole | Epoxiconazole | Kresoxim-methyl |
| 345 | Mancozeb | Chlorantraniliprole | Epoxiconazole | Trifloxystrobin |
| 346 | Mancozeb | Chlorantraniliprole | Hexaconazole | Azoxystrobin |
| 347 | Mancozeb | Chlorantraniliprole | Hexaconazole | Picoxystrobin |
| 348 | Mancozeb | Chlorantraniliprole | Hexaconazole | Pyraclostrobin |
| 349 | Mancozeb | Chlorantraniliprole | Hexaconazole | Kresoxim-methyl |
| 350 | Mancozeb | Chlorantraniliprole | Hexaconazole | Trifloxystrobin |
| 351 | Mancozeb | Chlorantraniliprole | Tebuconazole | Azoxystrobin |
| 352 | Mancozeb | Chlorantraniliprole | Tebuconazole | Picoxystrobin |
| 353 | Mancozeb | Chlorantraniliprole | Tebuconazole | Pyraclostrobin |
| 354 | Mancozeb | Chlorantraniliprole | Tebuconazole | Kresoxim-methyl |
| 355 | Mancozeb | Chlorantraniliprole | Tebuconazole | Trifloxystrobin |
| 356 | Mancozeb | Chlorantraniliprole | Tetraconazole | Azoxystrobin |
| 357 | Mancozeb | Chlorantraniliprole | Tetraconazole | Picoxystrobin |
| 358 | Mancozeb | Chlorantraniliprole | Tetraconazole | Pyraclostrobin |
| 359 | Mancozeb | Chlorantraniliprole | Tetraconazole | Kresoxim-methyl |
| 360 | Mancozeb | Chlorantraniliprole | Tetraconazole | Trifloxystrobin |
| 361 | Mancozeb | Chlorantraniliprole | Prothioconazole | Azoxystrobin |
| 362 | Mancozeb | Chlorantraniliprole | Prothioconazole | Picoxystrobin |
| 363 | Mancozeb | Chlorantraniliprole | Prothioconazole | Pyraclostrobin |
| 364 | Mancozeb | Chlorantraniliprole | Prothioconazole | Kresoxim-methyl |
| 365 | Mancozeb | Chlorantraniliprole | Prothioconazole | Trifloxystrobin |

In an embodiment of the combinations of the present invention, the preferred diamide insecticidal compound is Cyantraniliprole.

In an embodiment, the combinations of the present invention include the following preferred combinations:

| S No. | I | II | III | IV |
|---|---|---|---|---|
| 366 | Mancozeb | Cyantraniliprole | Cyproconazole | — |
| 367 | Mancozeb | Cyantraniliprole | Difenoconazole | — |
| 368 | Mancozeb | Cyantraniliprole | Epoxiconazole | — |
| 369 | Mancozeb | Cyantraniliprole | Hexaconazole | — |
| 370 | Mancozeb | Cyantraniliprole | Tebuconazole | — |
| 371 | Mancozeb | Cyantraniliprole | Tetraconazole | — |
| 372 | Mancozeb | Cyantraniliprole | Prothioconazole | — |
| 373 | Mancozeb | Cyantraniliprole | — | Azoxystrobin |
| 374 | Mancozeb | Cyantraniliprole | — | Picoxystrobin |
| 375 | Mancozeb | Cyantraniliprole | — | Pyraclostrobin |
| 376 | Mancozeb | Cyantraniliprole | — | Kresoxim-methyl |
| 377 | Mancozeb | Cyantraniliprole | — | Trifloxystrobin |
| 378 | Mancozeb | Cyantraniliprole | Cyproconazole | Azoxystrobin |
| 379 | Mancozeb | Cyantraniliprole | Cyproconazole | Picoxystrobin |
| 380 | Mancozeb | Cyantraniliprole | Cyproconazole | Pyraclostrobin |
| 381 | Mancozeb | Cyantraniliprole | Cyproconazole | Kresoxim-methyl |
| 382 | Mancozeb | Cyantraniliprole | Cyproconazole | Trifloxystrobin |
| 383 | Mancozeb | Cyantraniliprole | Difenoconazole | Azoxystrobin |
| 384 | Mancozeb | Cyantraniliprole | Difenoconazole | Picoxystrobin |
| 385 | Mancozeb | Cyantraniliprole | Difenoconazole | Pyraclostrobin |
| 386 | Mancozeb | Cyantraniliprole | Difenoconazole | Kresoxim-methyl |
| 387 | Mancozeb | Cyantraniliprole | Difenoconazole | Trifloxystrobin |
| 388 | Mancozeb | Cyantraniliprole | Epoxiconazole | Azoxystrobin |
| 389 | Mancozeb | Cyantraniliprole | Epoxiconazole | Picoxystrobin |
| 390 | Mancozeb | Cyantraniliprole | Epoxiconazole | Pyraclostrobin |
| 391 | Mancozeb | Cyantraniliprole | Epoxiconazole | Kresoxim-methyl |
| 392 | Mancozeb | Cyantraniliprole | Epoxiconazole | Trifloxystrobin |
| 393 | Mancozeb | Cyantraniliprole | Hexaconazole | Azoxystrobin |
| 394 | Mancozeb | Cyantraniliprole | Hexaconazole | Picoxystrobin |
| 395 | Mancozeb | Cyantraniliprole | Hexaconazole | Pyraclostrobin |
| 396 | Mancozeb | Cyantraniliprole | Hexaconazole | Kresoxim-methyl |
| 397 | Mancozeb | Cyantraniliprole | Hexaconazole | Trifloxystrobin |
| 398 | Mancozeb | Cyantraniliprole | Tebuconazole | Azoxystrobin |
| 399 | Mancozeb | Cyantraniliprole | Tebuconazole | Picoxystrobin |
| 400 | Mancozeb | Cyantraniliprole | Tebuconazole | Pyraclostrobin |
| 401 | Mancozeb | Cyantraniliprole | Tebuconazole | Kresoxim-methyl |
| 402 | Mancozeb | Cyantraniliprole | Tebuconazole | Trifloxystrobin |
| 403 | Mancozeb | Cyantraniliprole | Tetraconazole | Azoxystrobin |
| 404 | Mancozeb | Cyantraniliprole | Tetraconazole | Picoxystrobin |
| 405 | Mancozeb | Cyantraniliprole | Tetraconazole | Pyraclostrobin |
| 406 | Mancozeb | Cyantraniliprole | Tetraconazole | Kresoxim-methyl |
| 407 | Mancozeb | Cyantraniliprole | Tetraconazole | Trifloxystrobin |
| 408 | Mancozeb | Cyantraniliprole | Prothioconazole | Azoxystrobin |
| 409 | Mancozeb | Cyantraniliprole | Prothioconazole | Picoxystrobin |
| 410 | Mancozeb | Cyantraniliprole | Prothioconazole | Pyraclostrobin |
| 411 | Mancozeb | Cyantraniliprole | Prothioconazole | Kresoxim-methyl |
| 412 | Mancozeb | Cyantraniliprole | Prothioconazole | Trifloxystrobin |

In an embodiment of the combinations of the present invention, the preferred diamide insecticidal compound is Flubendiamide.

In an embodiment, the combinations of the present invention include the following preferred combinations:

| S No. | I | II | III | IV |
|---|---|---|---|---|
| 413 | Mancozeb | Flubendiamide | Cyproconazole | — |
| 414 | Mancozeb | Flubendiamide | Difenoconazole | — |
| 415 | Mancozeb | Flubendiamide | Epoxiconazole | — |
| 416 | Mancozeb | Flubendiamide | Hexaconazole | — |
| 417 | Mancozeb | Flubendiamide | Tebuconazole | — |
| 418 | Mancozeb | Flubendiamide | Tetraconazole | — |
| 419 | Mancozeb | Flubendiamide | Prothioconazole | — |
| 420 | Mancozeb | Flubendiamide | — | Azoxystrobin |
| 421 | Mancozeb | Flubendiamide | — | Picoxystrobin |
| 422 | Mancozeb | Flubendiamide | — | Pyraclostrobin |
| 423 | Mancozeb | Flubendiamide | — | Kresoxim-methyl |
| 424 | Mancozeb | Flubendiamide | — | Trifloxystrobin |
| 425 | Mancozeb | Flubendiamide | Cyproconazole | Azoxystrobin |
| 426 | Mancozeb | Flubendiamide | Cyproconazole | Picoxystrobin |
| 427 | Mancozeb | Flubendiamide | Cyproconazole | Pyraclostrobin |
| 428 | Mancozeb | Flubendiamide | Cyproconazole | Kresoxim-methyl |
| 429 | Mancozeb | Flubendiamide | Cyproconazole | Trifloxystrobin |
| 430 | Mancozeb | Flubendiamide | Difenoconazole | Azoxystrobin |
| 431 | Mancozeb | Flubendiamide | Difenoconazole | Picoxystrobin |
| 432 | Mancozeb | Flubendiamide | Difenoconazole | Pyraclostrobin |
| 433 | Mancozeb | Flubendiamide | Difenoconazole | Kresoxim-methyl |
| 434 | Mancozeb | Flubendiamide | Difenoconazole | Trifloxystrobin |
| 435 | Mancozeb | Flubendiamide | Epoxiconazole | Azoxystrobin |
| 436 | Mancozeb | Flubendiamide | Epoxiconazole | Picoxystrobin |
| 437 | Mancozeb | Flubendiamide | Epoxiconazole | Pyraclostrobin |
| 438 | Mancozeb | Flubendiamide | Epoxiconazole | Kresoxim-methyl |
| 439 | Mancozeb | Flubendiamide | Epoxiconazole | Trifloxystrobin |
| 440 | Mancozeb | Flubendiamide | Hexaconazole | Azoxystrobin |
| 441 | Mancozeb | Flubendiamide | Hexaconazole | Picoxystrobin |
| 442 | Mancozeb | Flubendiamide | Hexaconazole | Pyraclostrobin |
| 443 | Mancozeb | Flubendiamide | Hexaconazole | Kresoxim-methyl |
| 444 | Mancozeb | Flubendiamide | Hexaconazole | Trifloxystrobin |
| 445 | Mancozeb | Flubendiamide | Tebuconazole | Azoxystrobin |
| 446 | Mancozeb | Flubendiamide | Tebuconazole | Picoxystrobin |
| 447 | Mancozeb | Flubendiamide | Tebuconazole | Pyraclostrobin |
| 448 | Mancozeb | Flubendiamide | Tebuconazole | Kresoxim-methyl |
| 449 | Mancozeb | Flubendiamide | Tebuconazole | Trifloxystrobin |
| 450 | Mancozeb | Flubendiamide | Tetraconazole | Azoxystrobin |
| 451 | Mancozeb | Flubendiamide | Tetraconazole | Picoxystrobin |
| 451 | Mancozeb | Flubendiamide | Tetraconazole | Pyraclostrobin |
| 452 | Mancozeb | Flubendiamide | Tetraconazole | Kresoxim-methyl |
| 453 | Mancozeb | Flubendiamide | Tetraconazole | Trifloxystrobin |
| 454 | Mancozeb | Flubendiamide | Prothioconazole | Azoxystrobin |
| 455 | Mancozeb | Flubendiamide | Prothioconazole | Picoxystrobin |
| 456 | Mancozeb | Flubendiamide | Prothioconazole | Pyraclostrobin |
| 457 | Mancozeb | Flubendiamide | Prothioconazole | Kresoxim-methyl |
| 458 | Mancozeb | Flubendiamide | Prothioconazole | Trifloxystrobin |

The combinations of the present invention may be formulated in the form of a composition.

In an embodiment, the present invention may provide a composition comprising:

(a) at least one diamide insecticidal compound;
(b) at least one dithiocarbamate fungicide;
(c) at least one quinone outside inhibitor; and
(d) at least one agrochemically acceptable excipient.

In an embodiment, the present invention may provide a composition comprising:

(a) at least one diamide insecticidal compound;
(b) at least one dithiocarbamate fungicide;
(c) at least one ergostrol biosynthesis inhibitor; and
(d) at least one agrochemically acceptable excipient.

In an embodiment, the present invention may provide a composition comprising:

(a) at least one diamide insecticidal compound;
(b) at least one dithiocarbamate fungicide;
(c) at least one a quinone outside inhibitor;
(d) at least one ergostrol biosynthesis inhibitor; and
(e) at least one agrochemically acceptable excipient.

The amount of a composition according to the invention to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic disease control; in case of disease control the type of fungi to be controlled or the application time. This amount of the combinations of the present invention to be applied can be readily deduced by a skilled agronomist.

Thus in an embodiment, the present invention may provide compositions comprising:
[symbol] at least one diamide insecticide selected from broflanilide, chlorantraniliprole, cyantraniliprole, cyclaniliprole, cyhalodiamide flubendiamide, tetraniliprole;
[symbol] at least one quinone outside inhibitor, and/or at least one ergostrol biosynthesis inhibitor; and
[symbol] at last one dithiocarbamate fungicide.

In an embodiment, the total amount of diamide insecticidal compound in the composition may typically be in the range of 0.1 to 99% by weight, preferably 0.2 to 90% by weight. The total amount of dithiocarbamate fungicide in the composition may be in the range of 0.1 to 99% by weight. The total amount of ergostrol biosynthesis inhibitor in the composition may be in the range of 0.1 to 99% by weight. The total amount of Quinone outside inhibitor in the composition may be in the range of 0.1 to 99% by weight.

In an embodiment, the constituent fungicides of the combination of the present invention may be admixed in ratio of (1-80):(1-80):(1-80) of the dithiocarbamate fungicide, anthranilamide insecticidal compound and the second fungicide respectively.

In an embodiment, the constituents of the composition of the present invention may be tank mixed and sprayed at the locus of the infection, or may be alternatively be mixed with surfactants and then sprayed.

In an embodiment, the constituents of the composition of the present invention may be used for foliar application, ground or applications to plant propagation materials.

In an embodiment, the compositions of the present invention may typically be produce by mixing the actives in the composition with an inert carrier, and adding surfactants and other adjuvants and carriers as needed and formulated into solid, or liquid formulations, including but not limited to wettable powders, granules, dusts, Soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc.

Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

The compositions according to the present invention is effective for the following plant diseases:

Disease in rice: Blast (Magnaporthe grisea), Helminthosporium leaf spot (Cochliobolus miyabeanus), sheath blight (Rhizoctonia solani), and bakanae disease (Gibberella fujikuroi).

Diseases in wheat: powdery mildew (Erysiphe graminis), Fusariuin head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).

Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoeaa nanatis) and Rhizoctonia damping-off (Rhizoctonia solani).

Diseases of citrus: melanose (Diaporthe citri), scab (Elsinoe fawcetti), penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear: scab (Venturia nashicola, V. pirina), powdery mildew, black spot (Alternaria alternata J apanese pear pathotype), rust (Gymnosporangium haraeanum), and phytophthora fruit rot (Phytophtora cactorum).

Diseases of peach: brown rot (Monilinia fructicola), powdery mildew, scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon: anthracnose (Gloeosporium kaki), and leaf spot (Cercospora kaki, Mycosphaerella nawae).

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.).

Diseases of tomato: early blight (Alternaria solani), leaf mold (Cladosporium fulvum), and late blight (Phytophthora infestans).

Diseases of eggplant: brown spot (Phomopsis vexans), and powdery mildew (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion: rust (Puccinia allii), and downy mildew (Peronospora destructor).

Diseases of soybean: purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and R hizoctonia damping-off (Rhizoctonia solani).

Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).

Diseases of garden pea: powdery mildew (Erysiphe pisi), and root rot (Fusarium solani f. sp. pisi).

Diseases of potato: early blight (Alternaria solani), late blight (Phytophthora infestans), pink rot (Phytophthora erythroseptica), and powdery scab (Spongospora subterranean f. sp. subterranea).

Diseases of strawberry: powdery mildew (Sphaerotheca humuli), and anthracnose (Glomerella cingulata).

Diseases of tea: net blister blight (Exobasidium reticulatum), white scab (Elsinoe leucospila), gray blight (Pestalotiopsis sp.), and anthracnose (Colletotrichum theae-sinensis).

Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani).

Diseases of sugar beat: Cercospora leaf spot (Cercospora beticola), leaf blight (Thanatephorus cucumeris), Root rot (Thanatephorus cucumeris), and Aphanomyces root rot (Aphanomyces cochlioides).

Diseases of rose: black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).

Diseases of various groups: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish: Alternaria leaf spot (Alternaria brassicicola).

Diseases of turfgrass: dollar spot (Sclerotinia homeocarpa), and brown patch and large patch (Rhizoctonia solani).

Disease of banana: Black sigatoka (Mycosphaerella fijiensis), Yellow sigatoka (Mycosphaerella musicola).

Disease of sunflower: downy mildew (Plasmopara halstedii).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymixa spp. or Olpidium spp. and so on.

In an embodiment the insect pests controlled by the combinations of the present invention may belong to the class Insecta, Arachnida and Nematoda. Exemplary pests may include: from the order Lepidoptera, pests such as Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Coleoptera, pest such as Agriotes spp., Anthonomus spp., Atomaria linearis, Ceutorhynchus spp., Chaetocnema tibialis, Cosmopolites spp., Curculio spp., Dermestes spp., Diabrotica spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Tenebrio spp., Tribolium spp. and Trogoderma spp.; from the order Orthoptera, pests such as Blatta spp., Blattella spp., Gryllotalpa spp., Leucophaea maderae, Locusta spp., Periplaneta spp. and Schistocerca spp.; from the order Isoptera, pests such as Reticulitermes spp.; from the order Psocoptera pest such as, Liposcelis spp.; from the order Anoplura, pests such as Haematopinus spp., Linognathus spp., Pediculus spp., Pemphigus spp. and Phylloxera spp.; from the order Mallophaga pests such as Damalinea spp. and Trichodectes spp.; rom the order Thysanoptera, pests such as Frankliniella spp., Hercinothrips spp., Taeniothrips spp., Thrips palmi, Thrips tabaci and Scirtothrips aurantii; from the order Heteroptera, pests such as Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; from the order Homoptera, insect pests such as Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; from the order Hymenoptera, insect pests such as Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; from the order Diptera, insect pests such as Antherigona soccata, Bibio hortulanus, Ceratitis spp., Chrysomyia spp., Culex spp., Cuterebra spp., Dacus spp., Delia spp., Drosophila melanogaster, Liriomyza spp., Melanagromyza spp., Orseolia spp., Oscinella frit, Pegomyia hyoscyami, Phorbia spp., Rhagoletis pomonella, Sciara spp.; from the order Acarina, pests such as Acarus siro, Aceria sheldoni, Aculus schlechtendali, Amblyomma spp., Argas spp., Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Ornithodoros spp., Panonychus spp., Phyllocoptruta spp. (such as Phyllocoptruta oleivora), Polyphagotarsonemus latus, Psoroptes spp., Rhipicephalus spp., Rhizoglyphus spp., Sarcoptes spp., Tarsonemus spp. and Tetranychus spp.; and from the class Nematoda, the species of Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonlaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

The compositions of the present invention can be used in agricultural lands such as fields, paddy fields, lawns and orchards or in non-agricultural lands. The present invention may be used to control diseases in agricultural lands for cultivating the plants without any phytotoxicity to the plant.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the constituent fungicides of the combination of the present invention may be admixed in ratio of (1-80): (1-80): (1-80): (1:80)

In an aspect, the present invention may provide methods of controlling fungal and/or insecticidal pests at a locus, said method comprising applying a combination comprising:
(a) at least one diamide insecticide;
(b) at least multi-site fungicide; and
(c) at least a second fungicide.

In an aspect, the present invention may provide methods of controlling fungal and/or insecticidal pests at a locus, said method comprising applying a combination comprising:
(a) at least one diamide insecticide;
(b) at least multi-site fungicide; and
(c) at least a second and a third fungicide.

In an aspect, the present invention may provide methods of controlling fungal and/or insecticidal pests at a locus, said method comprising applying a combination comprising:
(a) at least one diamide insecticide;
(b) at least one quinone outside inhibitor and/or at least one ergostrol biosynthesis inhibitor; and
(c) at least one dithiocarbamate fungicide.

In an embodiment, the diamide insecticide, the quinone outside inhibitor fungicide, the ergosterol biosynthesis inhibitor fungicide, and the dithiocarbamate fungicide may be selected according to any of the preferred embodiments of the combinations described hereinabove

In an aspect, the present invention may provide methods of controlling fungal and/or insecticidal pests at a locus, said method comprising applying a composition comprising:
(a) at least one diamide insecticide;
(b) at least multi-site fungicide;
(c) at least a second fungicide; and
(d) at least an agriculturally acceptable adjuvant.

In an aspect, the present invention may provide methods of controlling fungal and/or insecticidal pests at a locus, said method comprising applying a composition comprising:
(a) at least one diamide insecticide;
(b) at least multi-site fungicide;
(c) at least a second and a third fungicide; and
(d) at least an agriculturally acceptable adjuvant.

The combinations of the present invention may be sold as a pre-mix composition or a kit of parts such that individual actives may be mixed before spraying. Alternatively, the kit of parts may contain the dithiocarbamate fungicide and the second and/or third fungicide pre-mixed and the diamide insecticide may be admixed with an adjuvant such that the two components may be tank mixed before spraying.

In another embodiment, a multi-site fungicide and a second and/or third fungicide may be pre-mixed and separate diamide insecticide admixed with an adjuvant may be added to a co-pack such that the fungicides and insecticide may be tank mixed before spraying.

An aspect of the present invention can provide a kit comprising:
a first fungicidal component comprising at least one multi-site fungicide;
an insecticidal component comprising at least one diamide insecticide selected from broflanilide, chlorantraniliprole, cyantraniliprole, cyclaniliprole, cyhalodiamide, flubendiamide and tetraniliprole; and
a second fungicidal component comprising at least a second fungicide.

Another aspect of the present invention can provide a kit comprising:
a first fungicidal component comprising at least one dithiocarbamate fungicide;
an insecticidal component comprising at least one diamide insecticide selected from broflanilide, chlorantraniliprole, cyantraniliprole, cyclaniliprole, cyhalodiamide, flubendiamide and tetraniliprole; and
a second fungicidal component comprising at least a second fungicide.

Yet another aspect of the present invention can provide a kit comprising:
a first fungicidal component comprising at least one multi-site fungicide, preferably a dithiocarbamate fungicide;
an insecticidal component comprising at least one diamide insecticide selected from broflanilide, chlorantraniliprole, cyantraniliprole, cyclaniliprole, cyhalodiamide, flubendiamide and tetraniliprole;
a second fungicidal component comprising at least a second fungicide; and
a third fungicidal component comprising at least a third fungicide.

The composition of the present invention maybe applied simultaneously as a tank mix or a formulation or may be applied sequentially. The application may be made to the soil before emergence of the plants, either pre-planting or post-planting. The application may be made as a foliar spray at different timings during crop development, with either one or two applications early or late post-emergence.

The compositions according to the invention can be applied before or after infection of the useful plants or the propagation material thereof by the fungi.

As demonstrated, the addition of a dithiocarbamate fungicide to a combination of diamide insecticidal compound which are combined with Quinone outside inhibitors and/or ergosterol biosynthesis inhibitors and/or a succinate dehydrogenase inhibitor fungicide, greatly improved the disease control as well as improved yield and demonstrated a synergistic effect. The lower the mixture performance in the disease control, the greater the additional benefit of the mancozeb when added to the compositions of the present invention.

As demonstrated, the mixing of multi-site fungicides with at least another fungicide and a diamide insecticidal compound greatly improved disease and insect pest control, as well as improved yield. The combination of fungicides and insecticides targeted insect and fungal pests making it an ideal combination for broad spectrum of pests and fungal diseases.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### EXAMPLES

Studies were conducted to compare the efficacy of the combination of amide insecticides with fungicides selected from the various classes and to compare their observed efficacy with the ‘expected_ efficacy when amide insecticides and fungicides were used to treat fungal and insect pests. Any difference between the observed and ‘expected_ efficacy could be attributed to synergy between the two compounds in the control of fungal and insect pests. The expected efficacy of a combination of amide insecticides with fungicides was calculated using the well-established Colby method.

In the Colby method, the expected (or predicted) response of a combination of actives is calculated by taking the product of the observed response for each individual component of the combination when applied alone divided by 100 and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective. (Colby, S. R., Weeds, 1967(15), p. 20-22) The Colby method requires only a single dose of each active applied alone and the mixture of both doses. The formula used to calculate the expected efficacy (EE) which was compared with the observed efficacy (OE) to determine the efficacy of the present invention is explained hereinbelow:

EE=(B efficacy+A efficacy−(B efficacy×A efficacy)/100)

The efficacy of the individual actives of the invention and their combinations were evaluated on various fungal and insect pests. The trial was carried out in Randomized Complete Block (RCB) method, all field trials were conducted using this method. Each trial was replicated three times and conducted under GEP guidelines. Application volumes were varied for each mixture. Such field trials were carried out at various locations so as to generate independent data, the locations were chosen randomly across India. Chlorantriniprole was the amide insecticide and mancozeb and azoxystrobin were the selected fungicides which were sprayed according to their recommended dosage.

The following formula was used to calculate the expected activity of mixtures containing active ingredients, A and B:

$$Expected ( E ) A + B - \frac{AB}{100}$$

### Where

A=observed efficacy of active ingredient (combination of bensulfuron methyl+metsulfuron methyl) A at the same concentration as used in the mixture.
B=observed efficacy of active ingredient B (third herbicide) at the same concentration as used in the mixture.

However, following formula was used to calculate the expected activity of mixtures containing three active ingredients, A, B and C:

$$Expected ( E ) A + B + C - \frac{( AB + AC + BC )}{100} + \frac{ABC}{10 , 000}$$

Where
   A=observed efficacy of active ingredient A at the same concentration as used in the mixture.
   B=observed efficacy of active ingredient B at the same concentration as used in the mixture.
   C=observed efficacy of active ingredient C at the same concentration as used in the mixture.

The actives tank mix combinations, application rates, plant species tested, and results are given in the following examples:

### Examples 1: Chlorantriniprole Mancozeb and Azoxystrobin

Field trials were carried out to test the synergy of the combination of the amide insecticide chlorantriniprole, with fungicides mancozeb and azoxystrobin. The field trials were carried out at various locations in India. The percentage efficacy was calculated after 10 days of applications. The target pests were Alternaria solani in tomato and Helicoverpa armigera in tomato and the results are recorded in the table below:

TABLE 1

| Dose | | % Disease control | | | | | |
|---|---|---|---|---|---|---|---|
| | Rate | Early Blight Control | | Early Blight Control | | Early Blight Control | |
| | Unit g/ml | in tomato 10DAA | | in tomato 10DAA | | in tomato 10DAA | |
| Active | ha | Expected | Actual | Expected | Actual | Expected | Actual |
| Untreated Check | | | 49.10 | | 74.23 | | 50.24 |
| Mancozeb + | 1750 g | | 82.11 | | 87.02 | | 80.80 |
| Azoxystrobin | | | | | | | |
| Chlorantriniprole | 150 g | | 1.91 | | 1.86 | | 2.70 |
| Mancozeb + | 1750 g + | 82.45 | 86.7 | 87.26 | 89.53 | 81.31 | 83.88 |
| Azoxystrobin + | 150 g | | | | | | |
| Chlorantriniprole | | | | | | | |

| | | | |
|---|---|---|---|
| Observed − Expected | 4.24 | 2.26 | 2.56 |
| efficacy | | | |

In the Colby method, the expected (or predicted) response of a combination of actives is calculated by taking the product of the observed response for each individual component of the combination when applied alone divided by 100 and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective.

Thus, when the combination of the present invention was analyzed using this method, it demonstrated an observed—expected value of greater than zero which is indicative of an unexpected efficacy. The basis of demonstration of unexpected efficacy by comparison with the Colby formula is that active (A) tested alone would kill a proportion of the target pests and leave the remaining portion (a %) as survivors. Similarly, active B tested alone will leave (b %) as survivors. When combined, A+B will, act independently on the target pest (if unexpected activity is absent); component A leaving a % survivors, which survivors will be controlled by component B; which has an overall effect of a %*b %*100. Subsequently, if the percent control is greater than that predicted by the Colby formula or stated conversely, if the difference between the observed control and the expected control is greater than zero; then unexpected enhancement in activity is acknowledged. The degree to which the difference is greater than zero is not itself critical as long as it is greater than zero; however greater the difference, more significant is the enhancement or the unexpectedness in control of the pest.

The results in Table 1 clearly demonstrate the synergy when chlorantriniprole was mixed with fungicides mancozeb and azoxystrobin, in the control of Alternaria solani in tomato. No phytotoxcitiy was observed and good yields were observed.

Further field trials were carried out to test the synergy of the combination amide fungicide chlorantriniprole in combination with fungicides for the control of Helicoverpa armigera in tomato. The field trials were carried out at various locations in India. The percentage efficacy was calculated after 10 days of applications and the results are recorded in the table below:

TABLE 2

| Dose | | % control of pest | | | | | |
|---|---|---|---|---|---|---|---|
| | Rate | Fruit Borer control | | Fruit Borer control | | Fruit Borer control | |
| | Unit g/ml | in tomato 10DAA | | in tomato 10DAA | | in tomato 10DAA | |
| Active | ha | Expected | Actual | Expected | Actual | Expected | Actual |
| Untreated Check | | | 8.8 | | 10.2 | | |
| Mancozeb + | 1750 g | | 2.14 | | 3.43 | | 1.8 |
| Azoxystrobin | | | | | | | |
| Chlorantriniprole | 150 g | | 75.8 | | 86.4 | | 88.4 |
| Mancozeb + | 1750 g + | 76.31 | 79.6 | 86.86 | 87.9 | 88.60 | 91.2 |
| Azoxystrobin + | 150 g | | | | | | |
| Chlorantriniprole | | | | | | | |

| | | | |
|---|---|---|---|
| Observed − Expected | 3.28 | 1.03 | 2.59 |
| efficacy | | | |

The results in tables 2 clearly demonstrate a synergy when an amide insecticide such as chlorantriniprole is combined with fungicides such as mancozeb and azoxystrobin in the control of Helicoverpa armigera in tomato. No phytotoxcitiy was observed and good yields were observed.

The instant invention is more specifically explained by above examples. However, it should be understood that the scope of the present invention is not limited by the examples in any manner. It will be appreciated by any person skilled in this art that the present invention includes aforesaid examples and further can be modified and altered within the technical scope of the present invention.

1. A combination comprising:
a. at least one multi-site fungicide;
b. at least one diamide insecticide selected from broflanilide, chlorantraniliprole, cyantraniliprole, cyclaniliprole, cyhalodiamide, flubendiamide and tetraniliprole; and
c. at least a second fungicide.

2. The combination as claimed in claim 1, wherein the multi-site fungicide is selected from the group consisting of dithiocarbamates, phthalimides, chloronitriles, inorganic fungicides, sulfamides, bis-guanidines, triazines, quinones, quinoxalines, dicoarboxamides and mixtures thereof.

3. The combination as claimed in claim 2, wherein the multi-site fungicide is a dithiocarbamate fungicide selected from asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb, and zineb.

4. The combination as claimed in claim 2, wherein the multi-site fungicide is a phthalimide fungicide selected from captan, captafol and folpet.

5. The combination as claimed in claim 2, wherein the multi-site fungicide is chlorothalonil.

6. The combination as claimed in claim 2, wherein the multi-site fungicide is a sulfamide fungicide selected from dichlofluanid and tolylfluanid.

7. The combination as claimed in claim 2, wherein the multi-site fungicide is a bis-guanidine fungicide selected from guazatine and iminoctadine.

8. The combination as claimed in claim 2, wherein the multi-site fungicide is anilazine.

9. The combination as claimed in claim 2, wherein the multi-site fungicide is dithianon.

10. The combination as claimed in claim 2, wherein the multi-site fungicide is a quinoxaline fungicide selected from quinomethionate and chlorquinox.

11. The combination as claimed in claim 2, wherein the multi-site fungicide is fluoroimide.

12. The combination as claimed in claim 2, wherein the multi-site fungicide is an inorganic fungicide selected from copper (II) hydroxide, copper oxychloride, copper (II) sulfate, basic copper sulfate, Bordeaux mixture, copper salicylate C7H403*Cu, cuprous oxide CU2O, and sulphur.

13. The combination as claimed in claim 1, wherein the second fungicide is selected from nucleic acids synthesis inhibitors, cytoskeleton and motor protein inhibitors, amino acids and protein synthesis inhibitors, respiration process inhibitors, signal transduction inhibitors, lipid synthesis and membrane integrity distruptors, sterol biosynthesis inhibitors, melanin synthesis inhibitors, cell wall biosynthesis inhibitors, host plant defence inductors and/or fungicides with unknown modes of action.

14. The combination of claim 1, wherein the wherein the multi-site fungicide is a
dithiocarbamate fungicide.

15. The combination of claim 1 further comprising
d. at least a third fungicide.

16. A composition comprising:
a. at least one multi-site fungicide;
b. at least one diamide insecticide selected from broflanilide, chlorantraniliprole, cyantraniliprole, cyclaniliprole, cyhalodiamide, flubendiamide and tetraniliprole;
c. at least a second fungicide;
d. at least an agrochemically acceptable excipient.

17. A method of controlling fungal and/or insecticidal pests at a locus, comprising applying the combination of claim 1 to the locus.

18. A method of controlling fungal and/or insecticidal pests at a locus, comprising applying the composition of claim 16 to the locus.

19. A kit of parts containing a first multi-site fungicide and a second and/or third fungicide pre-mixed and separate diamide insecticide admixed with an adjuvant such that the fungicides and insecticide are added to a co-pack and tank mixed before spraying.

20. An agrochemical combination comprising:
a. at least one insecticidal diamide compound selected from broflanilide, chlorantraniliprole, cyantraniliprole, cyclaniliprole, cyhalodiamide, flubendiamide and tetraniliprole;
b. at least one multi-site contact fungicide selected from:
(i) copper fungicides selected from copper oxychloride, copper sulfate, copper hydroxide and tribasic copper sulfate (Bordeaux mixture);
(ii) elemental sulfur;
(iii) dithiocarbamate fungicides selected from amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
(iv) phthalimide fungicides selected from folpet, captan and captafol;
(v) chlorothalonil;
(vi) sulfamide fungicides selected from dichlofluanid and tolylfluanid;
(vii) guanidine fungicides selected from dodine, guazantine and iminoctaadine;
(viii) anilazine;
(ix) dithianon; and
(x) combinations thereof;
and
c. at least a second fungicide, and optionally a third fungicide, wherein:
the second fungicide is selected from a strobilurin fungicide, or a conazole fungicide or a succinate dehydrogenase fungicide; or
the second and the third fungicide are selected from a strobilurin fungicide and a conazole fungicide respectively; or
the second and the third fungicide are selected from a strobilurin fungicide and a succinate dehydrogenase inhibitor fungicide respectively; and
the second the third fungicide are selected from a conazole fungicide and a succinate dehydrogenase inhibitor fungicide respectively;
wherein:
the succinate dehydrogenase inhibitor fungicide is selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid;
the conazole fungicide is selected from the group consisting of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, imazalil, oxpoconazole, pefurazoate, prochloraz, triflumizole, fenarimol, nuarimol, pyrifenox, pyrisoxazole, and triforine; and
the strobilurin fungicide is selected from the group consisting of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, and pyribencarb.

21. The agrochemical combination as claimed in claim 20, wherein:
the multisite fungicide is a dithiocarbamate fungicides selected from amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
the strobilurin fungicide is selected from the group consisting of azoxystrobin, picoxystrobin, kresoxim-methyl, pyraclostrobin and trifloxystrobin;
the succinate dehydrogenase inhibitor fungicide is selected from the group consisting of thifluzamide, bixafen, fluxapyroxad, isopyrazam, penthiopyrad, sedaxane and boscalid; and
the conazole fungicide is selected from the group consisting of prothioconazole, tebuconazole, hexaconazole, cyroconazole or epoxiconazole.

22. The agrochemical combination as claimed in claim 20, comprising:
a. at least one insecticidal diamide compound selected from chlorantraniliprole, cyantraniliprole, and flubendiamide;
b. mancozeb; and
c. a fungicide selected from azoxystrobin, picoxystrobin, kresoxim-methyl, pyraclostrobin, trifloxystrobin, thifluzamide, bixafen, fluxapyroxad, isopyrazam, penthiopyrad, sedaxane, boscalid, prothioconazole, tebuconazole, hexaconazole, cyroconazole, epoxiconazole or combinations thereof.

23. The agrochemical combination as claimed in claim 22, comprising:
(a) at least one insecticidal diamide compound selected from chlorantraniliprole, cyantraniliprole, and flubendiamide;
(b) mancozeb; and
(c) azoxystrobin.

24. The agrochemical combination as claimed in claim 22, comprising:
(a) at least one insecticidal diamide compound selected from chlorantraniliprole, cyantraniliprole, and flubendiamide;
(b) mancozeb;
(c) azoxystrobin; and
(d) cyroconazole, or tebuconazole.
